(19) United States
(12) Patent Application Publication
(10) Pub. No.: US 2010/0156595 A1
(43) Pub. Date: Jun. 24, 2010

(54) Control Panel for Controlling Information Processing System

(75) Inventors: Kwok Fong Wong, Hong Kong (HK); Pui Yi Ching, Hong Kong (HK)

Correspondence Address: BYIP, LTD., P.O. BOX 1484, GENERAL POST OFFICE, HONG KONG, HK

(73) Assignee: Kwok Fong Wong, Hong Kong (HK)

(21) Appl. No.: 12/563,178

(22) Filed: Sep. 21, 2009

Related U.S. Application Data
(63) Continuation-in-part of application No. 12/484,268, filed on Jun. 15, 2009, now abandoned.

(30) Foreign Application Priority Data
Dec. 24, 2008 (HK) 08113980.7

(51) Int. Cl. G05B 19/00

(52) U.S. Cl. 340/5.53

(57) ABSTRACT

A control panel for controlling an information processing system is provided. The control panel is an integral device and is capable of being integrated with the information processing system. The control panel includes a plurality of capacitive touch buttons assembled in a printed circuit board assembly, a fingerprint sensor assembled in the printed circuit assembly, at least a status indicator configured for showing the status of the capacitive touch buttons, a connector interface, a touch sensing processor, and a fingerprint sensing processor. The touch sensing processor is electrically connected to the capacitive touch buttons, the at least one status indicator, and the connector interface. The fingerprint sensing processor is electrically connected to the fingerprint sensor and the connector interface. The touch sensing processor and the fingerprint sensing processor are configured to respectively receive signals from the capacitive touch buttons and the fingerprint sensor, to process the signals into control signals and to transmit the control signals to the information processing system through the connector interface. The physical distance between the capacitive touch buttons and the fingerprint sensor within the printed circuit board assembly is generally equal to or greater than about 20 millimeters.

### CROSS-REFERENCE TO RELATED PATENT APPLICATIONS

This patent application claims priorities of Hong Kong Short Term Patent Application No. 08113980.7 filed on Dec. 24, 2008, the entire content of which is hereby incorporated by reference.

### FIELD OF THE PATENT APPLICATION

The present patent application generally relates to control devices for information processing systems and more particularly to a control panel having integrated capacitive touch buttons and a fingerprint sensor for controlling an information processing system.

### SUMMARY

A control panel for controlling an information processing system is provided. The control panel is an integral device and is capable of being integrated with the information processing system. The control panel includes a plurality of capacitive touch buttons assembled in a printed circuit board assembly, a fingerprint sensor assembled in the printed circuit assembly, at least a status indicator configured for showing the status of the capacitive touch buttons, a connector interface, a touch sensing processor, and a fingerprint sensing processor. The touch sensing processor is electrically connected to the capacitive touch buttons, the at least one status indicator, and the connector interface. The fingerprint sensing processor is electrically connected to the fingerprint sensor and the connector interface. The touch sensing processor and the fingerprint sensing processor are configured to respectively receive signals from the capacitive touch buttons and the fingerprint sensor, to process the signals into control signals and to transmit the control signals to the information processing system through the connector interface. The physical distance between the capacitive touch buttons and the fingerprint sensor within the printed circuit board assembly is generally equal to or greater than about 20 millimeters.

In one embodiment, the fingerprint sensor is a fingerprint scanner implemented by a flexible printed circuit, and the fingerprint scanner is configured for scanning a user's finger by radio frequency electromagnetic waves. In another embodiment, the fingerprint sensor is a fingerprint scanner implemented by an Indium Tin oxide (ITO) layer on a liquid crystal display (LCD) glass, and the fingerprint scanner is configure for scanning a user's finger by radio frequency electromagnetic waves. In yet another embodiment, the fingerprint sensor is a fingerprint scanner implemented by an ITO (Indium tin oxide) layer on a PET (polyethylene terephthalate) material, and the fingerprint scanner is configure for scanning a user's finger by radio frequency electromagnetic waves.

The control panel may also include at least a guiding indicator configured for guiding a user to perform a fingerprint scanning operation, the guiding indicator can be electrically connected with the fingerprint sensing processor.

The capacitive touch buttons can be transparent and attachable to the information processing system by a gluing material. The capacitive touch buttons can be formed by a transparent laminate and conductive traces disposed on the laminate.

In one embodiment, the transparent laminate is formed by two polyethylene terephthalate (PET) layers, and the conductive traces are made by transversely isotropic porous (TIP) materials. In another embodiment, the transparent laminate is formed by a liquid crystal display (LCD) glass, and the conductive traces are made by ITO (Indium tin oxide).

In one embodiment, the connector interface is a wired interface that complies with the I2C (Inter-Integrated Circuit) communication protocol or the USB (Universal Serial Bus) communication protocol. In another embodiment, the connector interface is a Bluetooth interface or an infrared interface.

### BRIEF DESCRIPTION OF THE DRAWINGS

Specific embodiments disclosed in the present patent application will now be described by way of example with reference to the accompanying drawings wherein:

FIG. 1 is a functional block diagram of a control panel for controlling an information processing system according to an embodiment of the present patent application;

FIG. 2 is a front view of the control panel illustrated in FIG. 1;

FIG. 3 is a perspective view of a laptop computer having the control panel illustrated in FIG. 1;

FIG. 4 is a front view of a LCD of a laptop having a control panel according to another embodiment of the present patent application;

FIG. 5 is a front view of a LCD of a laptop having a control panel according to yet another embodiment of the present patent application;

FIG. 6A is a top view of a LCD of a laptop having a control panel according to still another embodiment of the present patent application;

FIG. 6B is a front view of the LCD depicted in FIG. 6A;

FIG. 6C is a computer keyboard having a control panel according to another embodiment of the present patent application;

FIG. 7 is a schematic circuit diagram of a capacitive touch button circuit of the control panel illustrated in FIG. 1;

FIG. 8 is a schematic circuit diagram of a fingerprint sensor circuit of the control panel illustrated in FIG. 1; and

FIG. 9 is a functional block diagram of a control panel for controlling an information processing system according to still another embodiment of the present patent application.

### DETAILED DESCRIPTION

Reference will now be made in detail to embodiments of the control panel for controlling an information processing system in the present patent application, examples of which are also provided in the following description. Exemplary embodiments of the control panel for controlling an information processing system disclosed in the present patent application are described in detail, although it will be apparent to those skilled in the relevant art that some features that are not particularly important to an understanding of the control panel for controlling an information processing system may not be shown for the sake of clarity.

Furthermore, it should be understood that the control panel for controlling an information processing system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

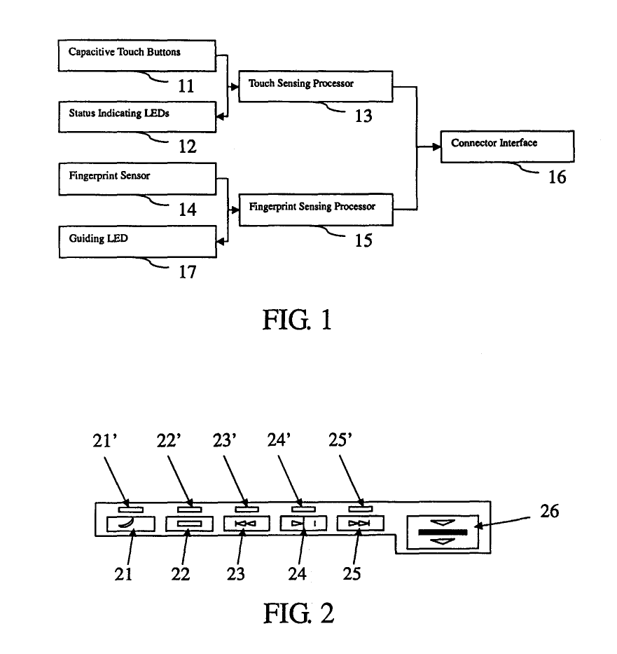

FIG. 1 is a functional block diagram of a control panel for controlling an information processing system according to an embodiment of the present patent application. The control panel includes a plurality of capacitive touch buttons 11, a plurality of status indicators, such as LEDs (light emitting diodes) 12, a touch sensing processor 13, a fingerprint sensor 14, a fingerprint sensing processor 15 and a connector interface 16.

The capacitive touch buttons 11 are assembled in a printed circuit board assembly and configured for receiving commands from a user for controlling an information processing system, such as a computer, to which the control panel is connected. In this embodiment, the capacitive touch buttons 11 are essentially switches controllable by the user's touch through a finger and can be assigned specific functions according the specific application that the information processing system is running. For example, when the capacitive touch buttons 11 are configured to control the information processing system in playing music, there can be six capacitive touch buttons respectively being assigned the functions of “fast forward”, “fast backward”, “turn to the previous song”, “turn to the next song”, “pause”, and “stop/play”. For another example, when a capacitive touch button 11 is configured to control the information processing system to clear its display, once the capacitive touch button 11 is touched, the touch sensing processor 13 issues a canceling command to the information processing system through the connector interface 16 so as stop the information processing system from running its current application and clear the information of the application from the display.

In this embodiment, the capacitive touch buttons 11 can be transparent and respectively attached to the surface of the information processing system by double-sided glue tapes. Such transparent capacitive touch buttons 11 are formed by a transparent laminate, which is formed by two PET (polyethylene terephthalate) layers, and conductive traces disposed on the PET layers. The conductive traces are made by TIP (transversely isotropic porous) materials. Alternatively, the transparent laminate can be formed by a LCD (liquid crystal display) glass, on which conductive ITO (Indium tin oxide) traces can be printed.

The status indicating LEDs 12 are configured for displaying the status of the capacitive touch buttons 11, and in this embodiment, the number of the status indicating LEDs 12 is set equal to the number of the capacitive touch buttons 11.

In this embodiment, the number is six. It is understood that the number of the status indicating LEDs can be set otherwise as required by the specific application of the capacitive touch buttons 11. The status of the capacitive touch buttons 11 can be indicated by the color or the blinking rate of the status indicating LEDs 12.

The touch sensing processor 13 is electrically connected with the capacitive touch buttons 11 and the status indicating LEDs 12, and configured to controlling the status indicating LEDs 12 to indicate the status of the capacitive touch buttons 11, to receive signals from the capacitive touch buttons 11, to process the signals into control signals, and to transmit the control signals to the information processing system through the connector interface 16 so as to interact with the application running on the information processing system.

In this embodiment, the fingerprint sensor 14 is a fingerprint scanner, such as a RF (radio frequency) fingerprint scanner which scans fingerprint by RF electromagnetic waves. The fingerprint scanner can be implemented by a FPC (Flexible Printed Circuit), by an ITO (Indium Tin oxide) layer on a LCD glass, or by an ITO (Indium tin oxide) layer on a PET (polyethylene terephthalate) material. The fingerprint sensor 14 is configured for detecting and scanning the image of a user's finger so that the user's identify can be verified and the user's access to the information processing system can be controlled accordingly.

The fingerprint sensing processor 15 is electrically connected with the fingerprint sensor 14 for processing the signal received by the fingerprint sensor 14 and transmitting a control signal to the information processing system through the connector interface 16 so as to lock or unlock the information processing system.

The connector interface 16 is electrically connected to the touch sensing processor 13, the fingerprint sensing processor 15 and the information processing system, functioning as a communication interface between the control panel and the information processing system. The connector interface 16 can be a wired interface such as an interface that complies with the I2C (Inter-Integrated Circuit) communication protocol or the USB (Universal Serial Bus) communication protocol, or alternatively a wireless interface such as a Bluetooth interface or an infrared interface.

The operation of the fingerprint sensor 14, the fingerprint sensing processor 15, and the connector interface 16 can be illustrated but not limited by the following examples. In one example, when the fingerprint sensor 14 detects, at least once, a fingerprint that is not previously registered with the signal processing system, the fingerprint sensing processor 15 is configured to transmit a locking command to the information processing system through the connector interface 16. This locking command can stop the information processing system from working or set the information processing system to a preconditioned operating state. In another example, when the information processing system is locked and then a previously registered fingerprint is detected, the fingerprint sensing processor 15 is configured to transmit an unlocking command to the information processing system through the connector interface 16 so that the information processing system is set back to a normal operating state. In yet another example, when the fingerprint sensor 14 is touched consecutively for more than once, the fingerprint sensing processor 15 is configured to transmit a locking command to the information processing system through the connector interface 16 so that the information processing system is locked and no access thereto is allowed until a registered fingerprint is detected and thereby unlocks the system.

In this embodiment, the control panel further includes a guiding indicator, such as a LED 17. The guiding LED 17 is electrically connected with the fingerprint sensing processor 15 and configured for displaying a guiding pattern to the user illustrating the correct direction of finger movement and the current scanning status during finger scanning. It is understood the number of the guiding LED can be more than one to realize more sophisticated guidance.

In this embodiment, the fingerprint sensor 14 and the capacitive touch buttons 11 are two independent units connected by an electrical wire or wirelessly connected by RF or other means.

FIG. 2 is a front view of the control panel according to this embodiment. Referring to FIG. 2, the control panel have five capacitive touch buttons 21, 22, 23, 24 and 25, five status indicating LEDs 21′, 22′, 23′, 24′, and 25′ respectively corresponding to the capacitive touch buttons 21-25, and a fingerprint sensor scanner 26.

In this embodiment, the control panel may further include an audio output device such as a speaker or a buzzer (not shown). The audio output device is electrically connected with the touch sensing processor 13 or the fingerprint sensor 14, and configured for providing an audio feedback regarding the switching status of the capacitive touch buttons 11 or the scanning status of the fingerprint sensor 14.

In this embodiment, the control panel may further include a solid state memory (not shown in FIG. 1) for storing information regarding the position and the status of the capacitive touch buttons 11, the fingerprint data and etc.

The different components of the control panel according to this embodiment can be physically integrated into one single device, in which the capacitive touch buttons 11 and the fingerprint sensor 14 are assembled in the same printed circuit board assembly. In this embodiment, to avoid interference between the capacitive touch buttons 11 and the fingerprint sensor 14, the physical distance between the capacitive touch buttons 11 and the fingerprint sensor 14 within the printed circuit board assembly is generally equal to or greater than about 20 millimeters. The control panel as an integral device can be disposed on and integrated with the information processing system. Preferably, the control panel is disposed on the information processing system by a reasonable distance to other touch sensing devices of the information processing system, such as a touchpad, so as to avoid accidental false triggering of the capacitive touch buttons 11 and the fingerprint sensor 14.

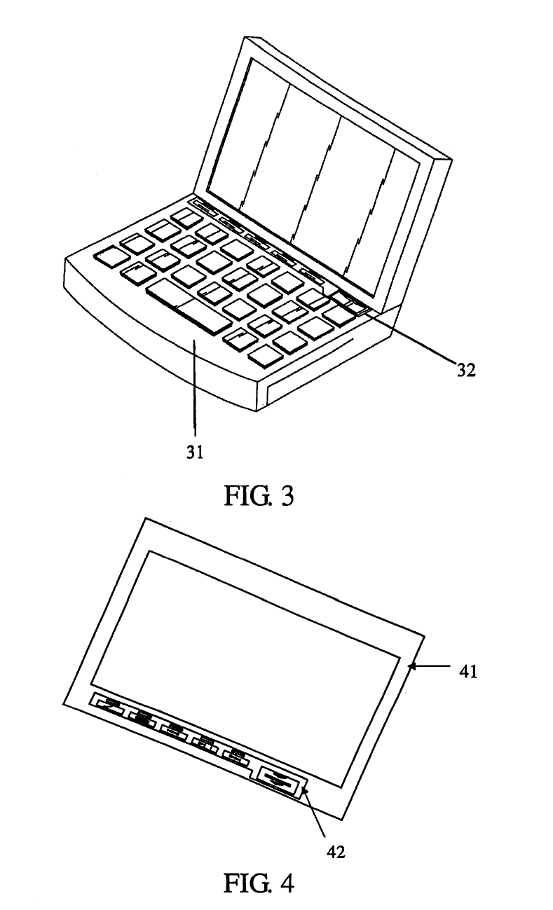

FIG. 3 is a perspective view of a laptop computer having a control panel according to this embodiment. The laptop computer 31 has a display, such as a LCD (liquid crystal display), a keyboard and a touchpad disposed beside the keyboard. The control panel 32 is disposed on and integrated with a portion of the keyboard of the laptop computer 31 that is close to the LCD and at least 2 cm away from the touchpad of the laptop computer 31.

FIG. 4 is a front view of a LCD of a laptop having a control panel according to another embodiment of the present patent application. In this embodiment, the control panel 42 is disposed on and integrated with a portion of LCD 41 that is close to the keyboard.

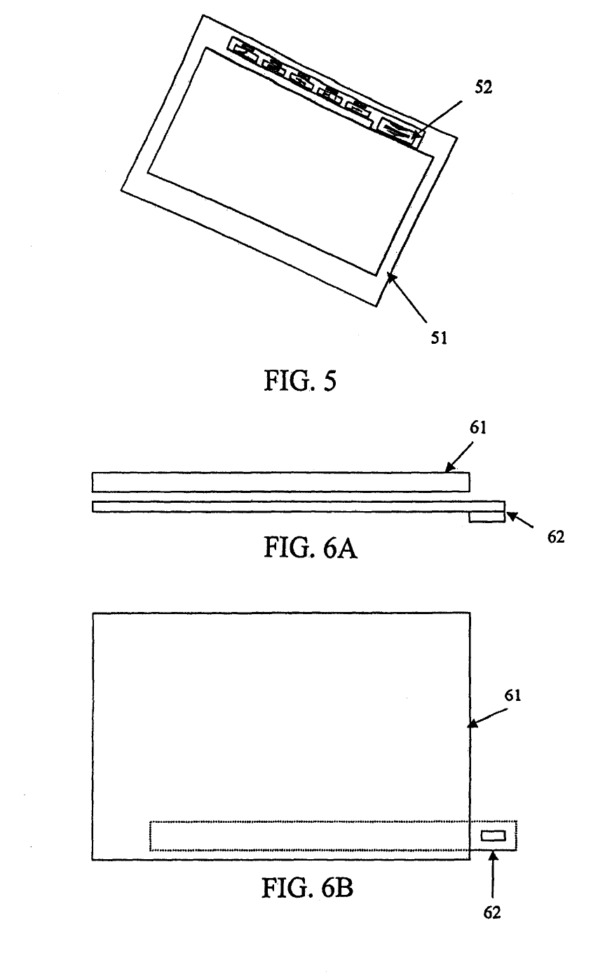

FIG. 5 is a front view of a LCD of a laptop having a control panel according to yet another embodiment of the present patent application. In this embodiment, the control panel 52 is disposed on and integrated with a portion of LCD 41 that is away from the keyboard.

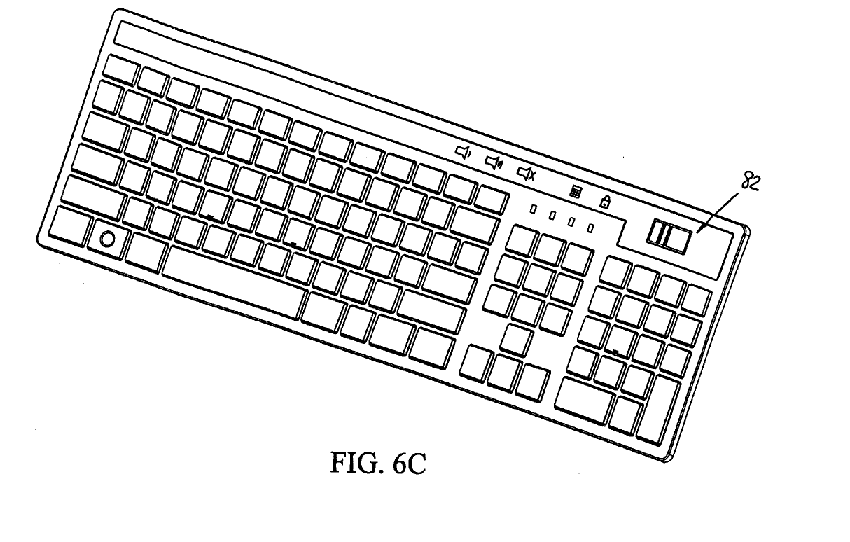

FIG. 6A is a top view of a LCD of a laptop having a control panel according to still another embodiment of the present patent application. FIG. 6B is a front view of the LCD depicted in FIG. 6A. In this embodiment, the control panel 62 is disposed below the LCD 61 so that a portion of the control panel 62 can be seen through the LCD 61.

FIG. 6C is a computer keyboard having a control panel according to another embodiment of the present patent application. The control panel includes capacitive touch buttons and a fingerprint sensor scanner. Status indicating LEDs respectively corresponding to the capacitive touch buttons are also included in the computer keyboard.

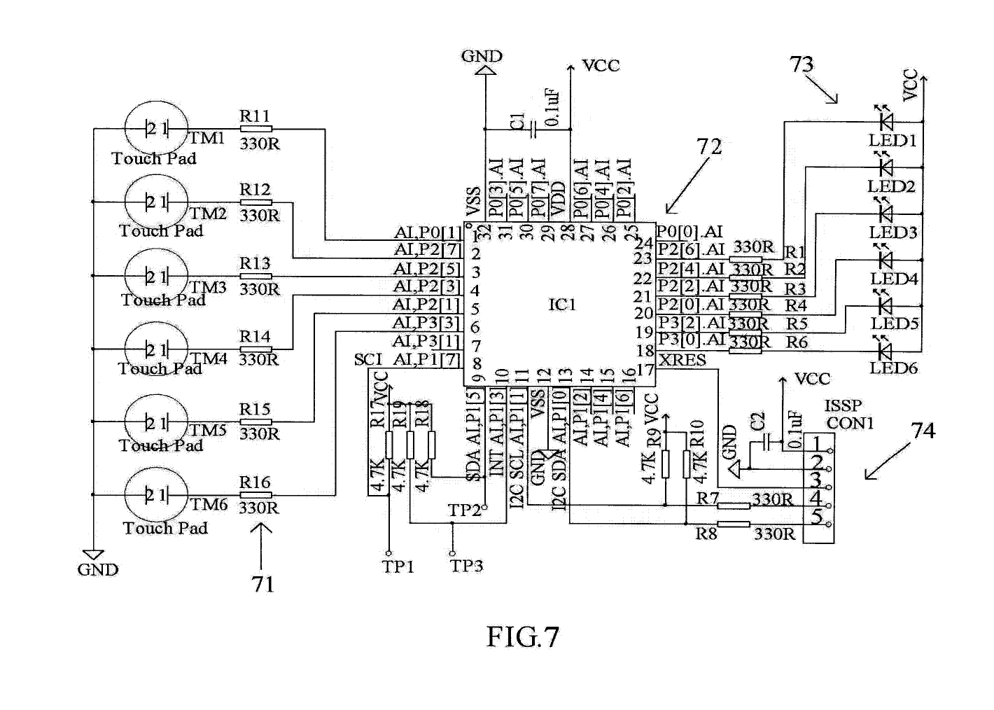

FIG. 7 is a schematic circuit diagram of a capacitive touch button circuit of the control panel illustrated in FIG. 1. The capacitive touch button circuit includes a circuit 71 corresponding to the capacitive touch buttons 11 in FIG. 1, a circuit 72 corresponding to the touch sensing processor 13 in FIG. 1, a circuit 73 corresponding to the status indicating LEDs 12 in FIG. 1 and a circuit 74 corresponding to the connector interface 16 in FIG. 1. The capacitive touch button circuit achieves the function of the capacitive touch buttons by transforming the signal sensed by the circuit 71 to a control signal, transmitting the control signal to the information processing system through the circuit 74, and displaying the status of the circuit 71 by the LEDs in the circuit 73.

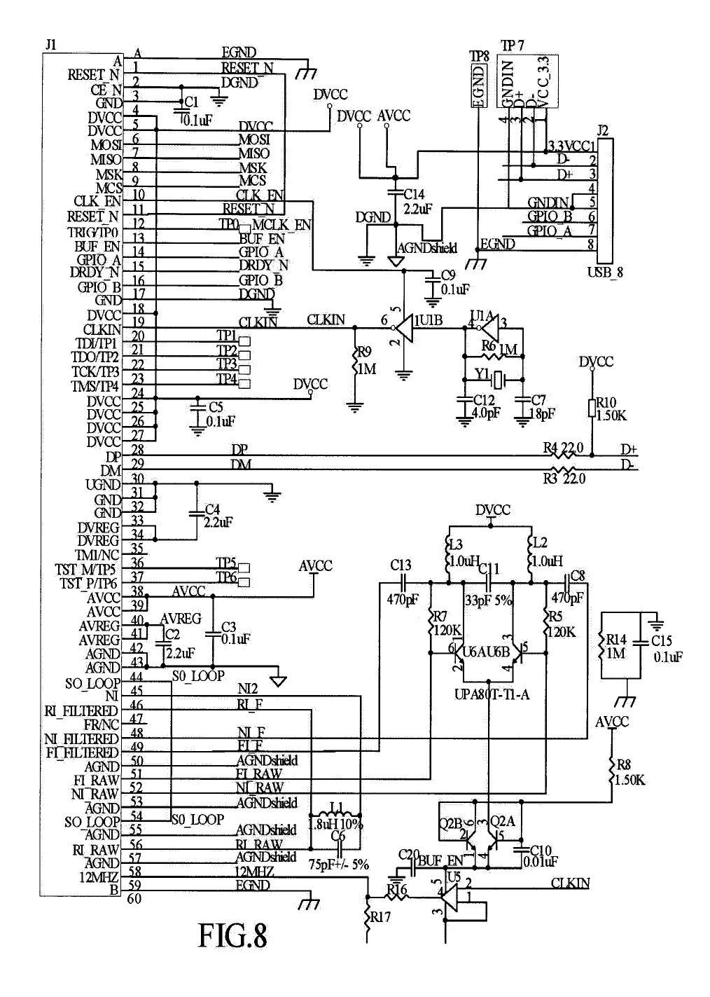

FIG. 8 is a schematic circuit diagram of a fingerprint sensor circuit of the control panel illustrated in FIG. 1. The fingerprint sensor circuit includes a circuit 81 corresponding to the fingerprint sensing processor 15 in FIG. 1, a circuit 82 corresponding to the fingerprint sensor 14 in FIG. 1, and a circuit 83 corresponding to the connector interface 16 in FIG. 1. The fingerprint sensor circuit achieves the function of fingerprint sensor by transforming the signal sensed by the circuit 82 to a control signal and transmitting the control signal to the information processing system through the circuit 83. In this embodiment, the control signal particularly corresponds to a locking or an unlocking command.

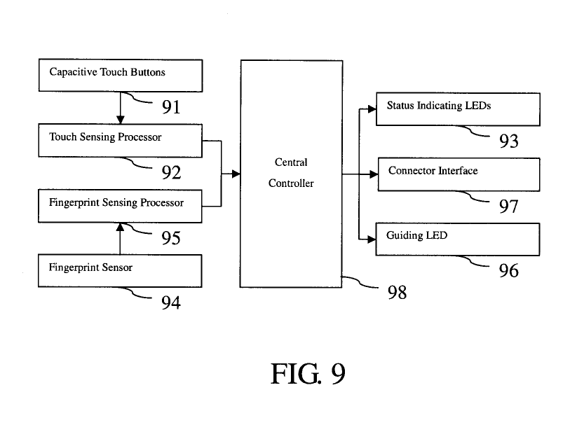

FIG. 9 is a functional block diagram of a control panel for controlling an information processing system according to still another embodiment of the present patent application. The control panel includes a plurality of capacitive touch buttons 91, a plurality of status indicating LED (light emitting diode) lights 93, a touch sensing processor 92, a fingerprint sensor 94, a guiding LED 96, a fingerprint sensing processor 95, a connector interface 97, and a central controller 98. The status indicating LEDs 93, the touch sensing processor 92, the guiding LED 96, the fingerprint sensing processor 95 and the connector interface 97 are respectively connected with the central controller 98. The central controller 98 controls the touch sensing processor 92 and the fingerprint sensing processor 95 to receive control signals for the information processing system respectively from the capacitive touch buttons 91 and the fingerprint sensor 94, and communicates with the information processing system through the connector interface 97 so as to control the information processing system with the control signals. In this embodiment, such control includes locking/unlocking and controlling the status of the applications that the information processing system is running.

In the above embodiments, the control panel can be used as a touch button panel and a fingerprint scanner simultaneously, or alternatively be used only as either a touch button panel or a fingerprint scanner at a time. The LEDs and the speaker or the buzzer in the control panel provide visual and audio feedback to the user when the control panel is in operation. By integrating various components into one integral functioning device, the size of the control panel is relatively small and the reliability of the control is improved.

While the present patent application has been shown and described with particular references to a number of embodiments thereof, it should be noted that various other changes or modifications may be made without departing from the scope of the present invention.

What is claimed is:

1. A control panel for controlling an information processing system, the control panel being an integral device and capable of being integrated with the information processing system, the control panel comprising:
a plurality of capacitive touch buttons assembled in a printed circuit board assembly;
a fingerprint sensor assembled in the printed circuit assembly;
at least a status indicator configured for showing the status of the capacitive touch buttons;
a connector interface;
a touch sensing processor electrically connected to the capacitive touch buttons, the at least one status indicator, and the connector interface; and
a fingerprint sensing processor electrically connected to the fingerprint sensor and the connector interface; wherein:
the touch sensing processor and the fingerprint sensing processor are configured to respectively receive signals from the capacitive touch buttons and the fingerprint sensor, to process the signals into control signals and to transmit the control signals to the information processing system through the connector interface, and the physical distance between the capacitive touch buttons and the fingerprint sensor within the printed circuit board assembly is generally equal to or greater than about 20 millimeters.

2. The control panel of claim 1, wherein the fingerprint sensor comprises a fingerprint scanner implemented by a flexible printed circuit, and the fingerprint scanner is configured for scanning a user's finger by radio frequency electromagnetic waves.

3. The control panel of claim 1, wherein the fingerprint sensor comprises a fingerprint scanner implemented by an Indium Tin oxide (ITO) layer on a liquid crystal display (LCD) glass, and the fingerprint scanner is configure for scanning a user's finger by radio frequency electromagnetic waves.

4. The control panel of claim 1, wherein the fingerprint sensor comprises a fingerprint scanner implemented by an ITO (Indium tin oxide) layer on a PET (polyethylene terephthalate) material, and the fingerprint scanner is configure for scanning a user's finger by radio frequency electromagnetic waves

5. The control panel of claim 1, wherein the at least one status indicator is configured for showing the status of the capacitive touch buttons by the color or the blinking rate thereof.

6. The control panel of claim 1, further comprising at least a guiding indicator configured for guiding a user to perform a fingerprint scanning operation, the at least one guiding indicator being electrically connected with the fingerprint sensing processor.

7. The control panel of claim 1, wherein the capacitive touch buttons are transparent and attachable to the information processing system by a gluing material.

8. The control panel of claim 7, wherein the capacitive touch buttons are formed by a transparent laminate and conductive traces disposed on the laminate.

9. The control panel of claim 8, wherein the transparent laminate is formed by two polyethylene terephthalate (PET) layers, and the conductive traces are made by transversely isotropic porous (TIP) materials.

10. The control panel of claim 8, wherein the transparent laminate is formed by a liquid crystal display (LCD) glass, and the conductive traces are made by ITO (Indium tin oxide).

11. The control panel of claim 1, wherein the connector interface is a wired interface that complies with the I2C (Inter-Integrated Circuit) communication protocol or the USB (Universal Serial Bus) communication protocol.

12. The control panel of claim 1, wherein the connector interface is a Bluetooth interface or an infrared interface.

13. The control panel of claim 1, further comprising an audio output device configured for providing audio feedback to a user about the status of the capacitive touch buttons or the status of the fingerprint sensor.

14. The control panel of claim 1, wherein the touch sensing processor is configured to transmit a control signal to the information processing system so as to control the access of a user thereto according to the signal received by the fingerprint sensor.

15. The control panel of claim 1, wherein the fingerprint sensor and the capacitive touch buttons are electrically connected.

16. An information processing system comprising:
a keyboard;
a touchpad disposed on the keyboard;
a display electrically connected to the keyboard; and
a control panel as claimed in claim 1.

17. The information processing system of claim 16, wherein the control panel is disposed on and integrated with a portion of the keyboard that is close to the display, and at least about 20 millimeters away from the touchpad.

18. The information processing system of claim 16, wherein the control panel is disposed on and integrated with a portion of the display that is close to the keyboard.

19. The information processing system of claim 16, wherein the control panel is disposed on and integrated with a portion of the display that is away from the keyboard.

20. The information processing system of claim 16, wherein the control panel is integrated with and disposed below the display so that a portion of the control panel is visible through the display.

21. A control panel for controlling an information processing system, the control panel being an integral device and capable of being integrated with the information processing system, the control panel comprising:
a plurality of capacitive touch buttons assembled in a printed circuit board assembly;
a fingerprint sensor assembled in the printed circuit assembly;
at least a status indicator configured for showing the status of the capacitive touch buttons;
at least a guiding indicator configured for guiding a user to perform a fingerprint scanning operation;
a connector interface;
a touch sensing processor electrically connected to the capacitive touch buttons;
a fingerprint sensing processor electrically connected to the fingerprint sensor; and
a central controller electrically connected with the touch sensing processor, the fingerprint sensing processor, the at least one status indicating indicator, the at least a guiding indicator and the connector interface; wherein:
the central controller is configured to control the touch sensing processor and the fingerprint sensing processor to receive control signals for the information processing system respectively from the capacitive touch buttons and the fingerprint sensor, and to communicate with the information processing system through the connector interface so as to control the information processing system with the control signals, and the physical distance between the capacitive touch buttons and the fingerprint sensor within the printed circuit board assembly is generally equal to or greater than about 20 millimeters.
